(19) United States
(12) Patent Application Publication
(10) Pub. No.: US 2017/0124889 A1
(43) Pub. Date: May 4, 2017

(54) MANAGEMENT APPARATUS, METHOD, AND COMPUTER READABLE MEDIUM

(71) Applicant: DAncing Einstein Co., Ltd., Tokyo (JP)

(72) Inventor: Mizuto AOTO, Tokyo (JP)

(73) Assignee: DAncing Einstein Co., Ltd.

(21) Appl. No.: 15/336,488

(22) Filed: Oct. 27, 2016

(30) Foreign Application Priority Data
Oct. 28, 2015 (JP) 2015-212373
Aug. 9, 2016 (JP) 2016-156577

(51) Int. Cl. G09B 5/02; G09B 17/00

(52) U.S. Cl. CPC G09B 5/02; G09B 17/00

(57) ABSTRACT

A computer implemented method includes reproducing first content activating a first site of a user brain, the first content being associated with a learning target item to be learned by the user, reproducing second content activating a second site of the user brain, the second content being associated with the learning target item, presenting a question about the learning target item after the first content and the second content are reproduced, and presenting a correct answer to the question.

### CROSS-REFERENCE TO RELATED APPLICATIONS

This application claims the benefit of priority to Japanese Patent Application No. 2015-212373, filed on Oct. 28, 2015, and Japanese Patent Application No. 2016-156577, filed on Aug. 9, 2016, the entire contents of both of which are hereby incorporated by reference.

### BACKGROUND

Technical Field

The present invention relates to a management apparatus, a method, and a non-transitory computer readable medium that assist in learning.

Description of the Background

Systems for increasing learning efficiency have been developed (refer to, for example, Japanese Translation of PCT International Application Publication No. 2014-516170). One such system includes user terminals and a server that can communicate with the terminals. The server transmits learning item information to each terminal.

Japanese Patent Application Laid-Open Publication No. 2001-42758 describes a learning support apparatus that displays a subliminal image associated with a word to be learned.

### BRIEF SUMMARY

The learning support system described in Japanese Translation of PCT International Application Publication No. 2014-516170 personalizes learning targets for each user. The learning support system described in Japanese Patent Application Laid-Open Publication No. 2001-42758 displays subliminal images. However, neither of these systems is designed based on brain processing in memorizing a learning target.

Such learning support systems known in the art are not based on brain memorization processes, and thus show limited efficiency of assisting in memorizing learning targets.

One or more aspects of the present invention are directed to improving the efficiency of memorization.

According to one aspect of the present invention, a computer implemented method, comprising:

reproducing first content activating a first site of a user brain, the first content being associated with a learning target item to be learned by the user;

reproducing second content activating a second site of the user brain, the second content being associated with the learning target item;

presenting a question about the learning target item after the first content and the second content are reproduced; and

presenting a correct answer to the question.

### BRIEF DESCRIPTION OF THE DRAWINGS

FIG. 1 is a block diagram of the information processing system according to the present embodiment.

FIG. 2 is a diagram showing the data structure of the user information database shown in FIG. 1.

FIG. 3 is a diagram showing the data structure of the content database shown in FIG. 1.

FIG. 4 is a diagram showing the data structure of the cognitive state database shown in FIG. 1.

FIG. 5 is a diagram showing the data structure of the learning state database shown in FIG. 1.

FIG. 6 is a diagram showing the data structure of the learning item prioritization database shown in FIG. 1.

FIG. 7 is a diagram showing the relationship between the user information database in FIG. 2 and the content database in FIG. 3.

FIG. 8 is a diagram showing the hardware configuration of the management server and the terminal in FIG. 1.

FIG. 9 is a flowchart illustrating the overall information processing according to the embodiment of the present invention.

FIG. 10 is a sequence diagram illustrating the user registration process in FIG. 9.

FIG. 11 is a sequence diagram illustrating the pretest process in FIG. 9.

FIG. 12 is a diagram showing a display example for the first emotion determination test according to the present embodiment.

FIG. 13 is a diagram showing a display example for the second emotion determination test according to the present embodiment.

FIG. 14 is a flowchart of the MSL process in FIG. 9.

FIGS. 15 to 22 show display examples in the MSL process shown in FIG. 14.

### DETAILED DESCRIPTION

Embodiments of the present invention will be described with reference to the drawings.

### 1. Information Processing System

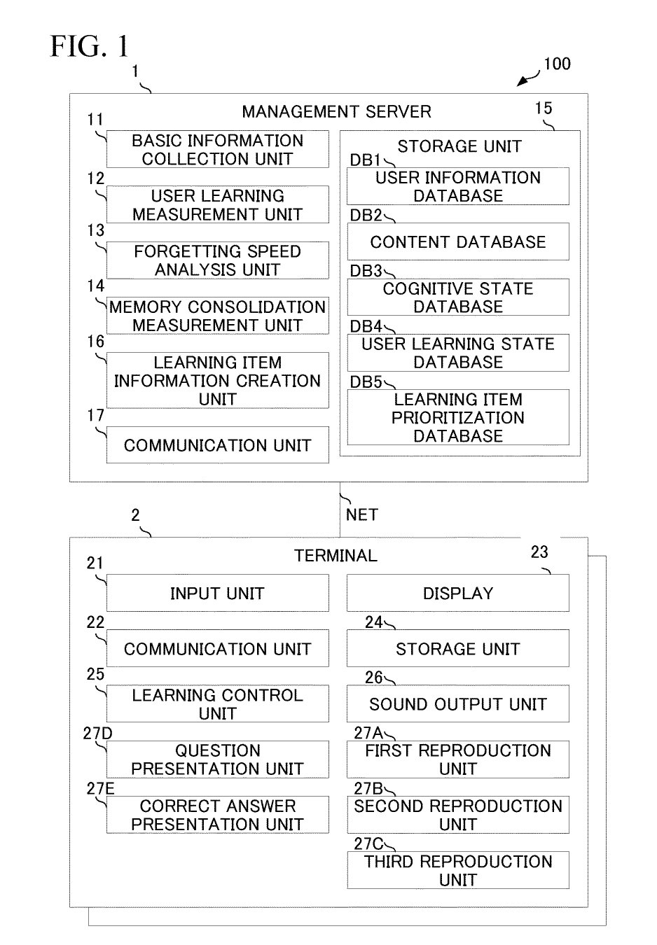

An information processing system according to the present embodiment will now be described. FIG. 1 is a block diagram of the information processing system according to the present embodiment.

As shown in FIG. 1, the information processing system 100 includes a management server 1 and a plurality of terminals 2. Each terminal 2 can communicate with the management server 1 through a communication network NET.

The communication network NET is, for example, the Internet, a wide area network (WAN), a local area network (LAN), a private network (e.g., intranet), or a combination of these networks.

A learning application program according to the present embodiment includes a first learning application program executed by the management server 1 and a second learning application program executed by each terminal 2.

The terminal 2 reproduces content (including first content and second content) associated with an item to be learned by a user (hereafter referred to as a learning item).

The terminal 2 is an example of an information processing apparatus that transmits a request to the management server 1. The terminal 2 is, for example, a smartphone, a tablet, or a personal computer.

The management server 1 is an example of a management apparatus that provides the terminal 2 with a response corresponding to the request from the terminal 2. The management server 1 is, for example, a web server.

The first content can activate the amygdala of the user brain. The first content is, for example, a subliminal image, a subliminal sound, or a combination of these. The image is a picture which humans visually cognize. The image is, for example, a character, a figure, or a combination of these.

Subliminal sounds are broadly classified into two categories described below.

Subliminal sounds in the first category are defined by their frequencies. More specifically, a subliminal sound in this category has a frequency which humans do not aurally cognize. Such subliminal sounds, which the humans do not aurally cognize, can stimulate the brain without its conscious awareness. The subliminal sounds in the first category can enhance human concentration, memory consolidation, or a combination of these.

Subliminal sounds in the second category are defined by the modes of reproducing such subliminal sounds. More specifically, a subliminal sound in this category is reproduced so that humans do not cognize the subliminal sound unless humans direct their attention to the sound. In other words, a subliminal sound in this category is aurally cognized when the attention is directed to the sound although the subliminal sound is not aurally cognized if the attention is not directed to the sound. This subliminal sound is, for example, a sound reproduced for a short time, a sound reproduced at a low volume level, or a combination of these. Music played in a cafe for customers reading books may be classified in this second category. The subliminal sounds in the second category can enhance human concentration, memory consolidation, or a combination of these.

Subliminal images are broadly classified into two categories described below.

Subliminal images in the first category are defined by wavelengths. More specifically, a subliminal image in this category includes a color having a wavelength which humans do not visually cognize. Such subliminal images, which the humans do not visually cognize, can stimulate the brain without its conscious awareness. The subliminal images in the first category can enhance human concentration, memory consolidation, or a combination of these.

Subliminal images in the second category are defined by the modes of reproducing such subliminal images. More specifically, a subliminal image is reproduced so that humans do not cognize the subliminal image unless humans direct their attention to the image. In other words, a subliminal image in this category is visually cognized when the attention is directed to the image although the subliminal image is not visually cognized if the attention is not directed to the image. This subliminal image is, for example, an image reproduced for a short time, an image reproduced with a small size, a background image, or a combination of these.

The first content relates to a person's emotions aroused in connection with the related learning item. The amygdala controls emotional memory. The first content reproduced on the terminal 2 can activate the amygdala of the user.

The second content can activate the hippocampus of the user brain. The second content is, for example, associated with the meaning of a learning item (an image, a sound, or a combination of these). The second content is visually or aurally cognized by the user.

The hippocampus controls semantic memory. The second content reproduced on the terminal 2 can activate the hippocampus of the user.

After reproducing the first content and the second content, the terminal 2 reproduces third content to present a question associated with the learning item and to present its correct answer.

The third content facilitates the release of dopamine in the ventral tegmental area of the user brain. The third content is, for example, a subliminal image, a subliminal sound, or a combination of these.

The release of dopamine in the ventral tegmental area is typically known to enhance the association of emotional memory with semantic memory in a site called the insular cortex, and enhance memory consolidation. In the present embodiment, two or more sites of the brain (e.g., the amygdala and the hippocampus) can be activated and the memory retained in these sites (e.g., emotional memory and semantic memory) can be associated. This can greatly improve the efficiency of memorization. In addition, the dopamine applied to at least one of the amygdala or the hippocampus consolidates at least one of emotional memory controlled by the amygdala or semantic memory controlled by the hippocampus.

### 1-1. Functions of Management Server

The functions of the management server 1 will be described with reference to FIG. 1. The management server 1 includes, as its function units, a basic information collection unit 11, a user learning measurement unit 12, a forgetting speed analysis unit 13, a memory consolidation measurement unit 14, a storage unit 15, a learning item information creation unit 16, and a communication unit 17.

The storage unit 15 stores databases DB1 to DB5 (described later), the first learning application program, and the second learning application program.

The first learning application program is executed in the management server 1.

The second learning application program is transmitted to a terminal 2 as requested from the terminal 2, and is executed in the terminal 2.

### 1-1-1. User Information Database

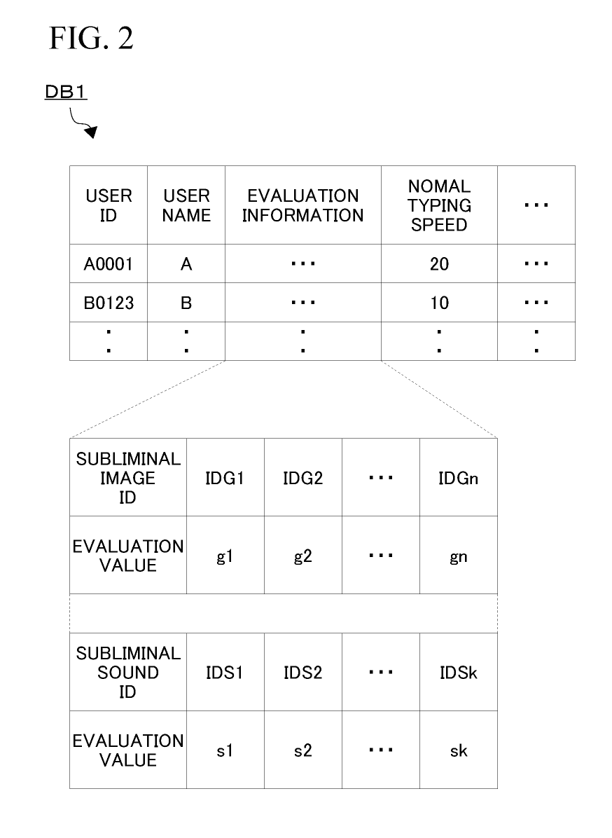

A user information database according to the present embodiment will be described. FIG. 2 is a diagram showing the data structure of the user information database shown in FIG. 1.

As shown in FIG. 2, the user information database DB1 includes a user ID field, a user name field, an evaluation information field, and a normal typing speed field. Although not shown, the user information database DB1 further includes a gender field, a date of birth field, an age field, and an email address field. These fields are associated with one another.

The user ID field stores user IDs for uniquely identifying users. A user ID is, for example, information for uniquely identifying the second learning application program stored in a storage unit 43, information for uniquely identifying the terminal 2 used by the user, a telephone number assigned to the terminal 2, a web service account registered by the user (e.g., an email address or a social networking service account), or a combination of these.

The user name field stores text strings representing user names.

The evaluation information field stores evaluation information representing the evaluation of user responses to the first content reproduced on the terminal 2. The evaluation information involves users' preferences (e.g., responses based on users' emotions). In the present embodiment, “emotions” includes “mood” and “feeling”. “Mood” causes a body to react unconsciously or automatically in response to the stimuli. “Feeling” causes the user to cognize the reaction due to the “mood”.

The evaluation information field stores information about subliminal images and information about subliminal sounds.

The information about subliminal images includes a subliminal image ID field and an evaluation value field. These fields are associated with each other.

The subliminal image ID field stores subliminal image IDs IDG1 to IDGn for uniquely identifying n subliminal images (n is a given natural number not less than 2).

The evaluation value field stores evaluation values g1 to gn for the n subliminal images. Each evaluation value is determined in a pretest process (described later).

The information about subliminal sounds includes a subliminal sound ID field and an evaluation value field. These fields are associated with each other.

The subliminal sound ID field stores subliminal sound IDs IDS1 to IDSk for uniquely identifying k subliminal sounds (k is a given natural number not less than 2).

The evaluation value field stores evaluation values s1 to sk for the k subliminal sounds. Each evaluation value is determined in the pretest process (described later).

The normal typing speed field stores information representing users' normal typing speeds (e.g., the numbers of characters that can be typed per 10 seconds). Each normal typing speed is determined in a user registration process (described later).

### 1-1-2. Content Database

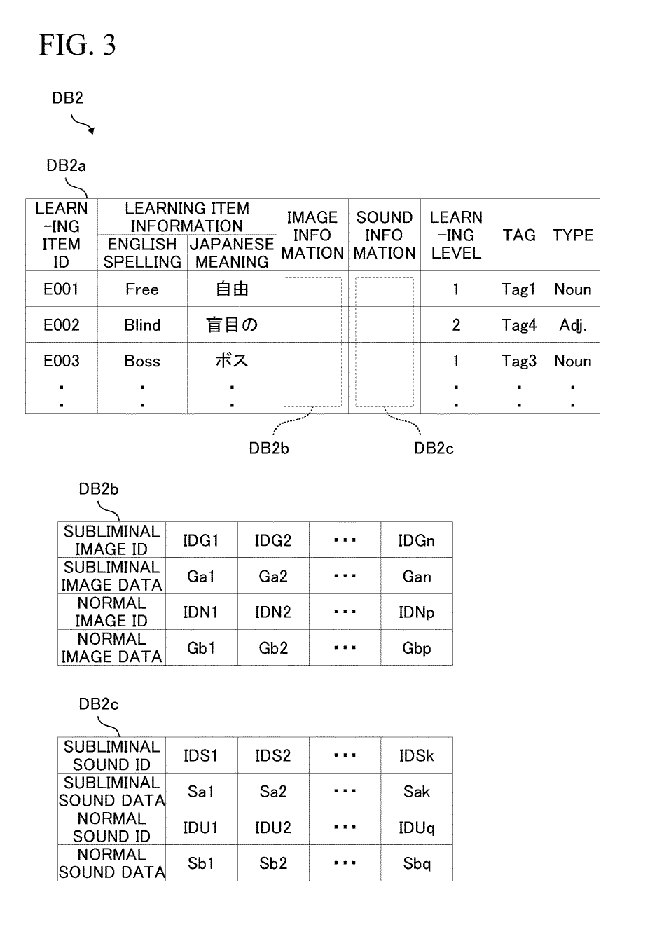

A content database according to the present embodiment will be described. FIG. 3 is a diagram showing the data structure of the content database shown in FIG. 1.

As shown in FIG. 3, the content database DB2 includes a first content database DB2a, a second content database DB2b, and a third content database DB2c.

The first content database DB2a includes a learning item ID field, a learning item information field, an image information field, a sound information field, a learning level field, a tag field, and a type field. These fields are associated with one another.

The learning item ID field stores learning item IDs for uniquely identifying learning items.

The learning item information field stores information about the learning items (hereafter referred to as the learning item information). The learning item information in this example is word information representing the spelling and the Japanese meaning of English words. The learning item information field in this example includes an English spelling subfield and a Japanese meaning subfield. The English spelling subfield stores text strings representing the spelling of English words (e.g., English text strings). The Japanese meaning subfield stores text strings representing the meaning of English words (e.g., Japanese text strings).

The image information field stores image information. The image information designates images (a subliminal image and a normal image) used for learning a learning item (e.g., an English word). The image information field corresponds to the second content database DB2b.

The second content database DB2b includes a subliminal image ID field, a subliminal image data field, a normal image ID field, and a normal image data field.

The subliminal image ID field is the same as the field shown in FIG. 2.

The subliminal image data field stores subliminal image data corresponding to n subliminal images.

The normal image ID field stores normal image IDs IDN1 to IDNp for uniquely identifying normal images.

The normal image data field stores normal image data corresponding to p normal images (p is a natural number not less than 2).

In this example, n subliminal images are used. A single learning item is assigned one or more subliminal images, and one or more normal images. For example, the English word “Free” is assigned three subliminal images (subliminal image IDs IDG1 to IDG3). The English word “Blind” is assigned two subliminal images (subliminal image IDs IDG4 and IDG5). The English word “Happy” is assigned one subliminal image (subliminal image ID IDG3).

The sound information field stores sound information. The sound information designates sounds (a subliminal sound and a normal sound) used for learning a learning item. The sound information field corresponds to the third content database DB2c.

The third content database DB2c includes a subliminal sound ID field, a subliminal sound data field, a normal sound ID field, and a normal sound data field.

The subliminal sound ID field is the same as the field shown in FIG. 2.

The subliminal sound data field stores subliminal sound data corresponding to k subliminal sounds (k is a natural number not less than 2).

The normal sound ID field stores normal sound IDs IDS1 to IDSq for uniquely identifying normal sounds.

The normal sound data field stores normal sound data corresponding to q normal sounds (q is a natural number not less than 2).

In this example, k subliminal sounds are used. A single learning item is assigned one or more subliminal sounds, and one or more normal sounds. For example, the English word “Free” is assigned two subliminal sounds (subliminal sound IDs IDS1 and IDS2). The English word “Blind” is assigned three subliminal sounds (subliminal sound IDs IDS3 to IDS5). The English word “Happy” is assigned one subliminal sound (subliminal sound ID IDS1).

The learning level field stores learning levels representing the degrees of difficulty of the learning items. For example, the learning levels are the values of 1 to 20.

The tag field stores information representing the types of stimuli provided from the meanings of the learning items to the users' emotions (hereafter referred to as the emotional stimulus).

For example, a tag Tag1 indicates that a learning item can have an effect on emotions. A tag Tag2 indicates that a learning item can have no effect on emotions. A tag Tag3 indicates that a learning item can give a positive impression. A tag Tag4 indicates that a learning item can give a negative impression.

The type field stores type information representing the type of the learning items. For example, the type is a part of speech of the English words, such as “noun”, “verb”, “adjective”, or the like.

As described above, some learning items (e.g., learning items with the tag Tag2) can have little or no effect on the users' emotions, whereas the first content affects the emotional memory. The first content may not be assigned to such learning items that have little or no effect on the users' emotions.

The content database DB2 functions as a first storage unit. The first storage unit stores, for each learning item, learning item information and a plurality of pieces of first content associated with the learning item.

The user information database DB1 functions as a second storage unit. The second storage unit stores, for each piece of first content, evaluation information representing the evaluation of a user response to the first content piece reproduced on the terminal 2 for a predetermined time period, and a user ID identifying the user. During the predetermined time, the first content piece is not cognized by humans and can stimulate them without their conscious awareness. The evaluation information and the user ID are associated with each other.

### 1-1-3. Cognitive State Database

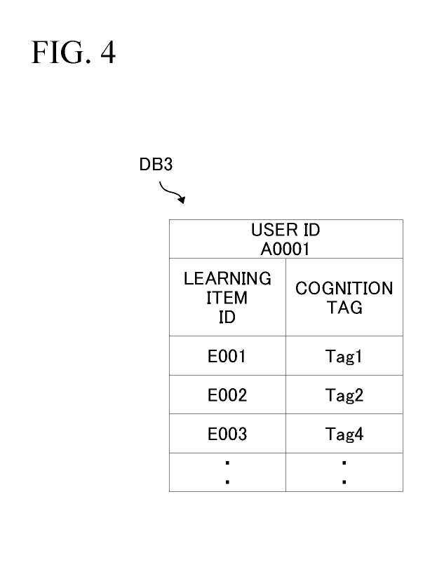

A cognitive state database according to the present embodiment will be described. FIG. 4 is a diagram showing the data structure of the cognitive state database shown in FIG. 1.

A cognitive state database DB3 stores, for each learning item, information representing the cognitive state of the user for the learning item.

The cognitive state database DB3 is associated with a user ID.

The cognitive state database DB3 includes a learning item ID field and a cognition tag field.

The learning item ID field stores learning item IDs.

The cognition tag field stores cognition tags. The cognition tags are determined by cognitive test data.

A cognition tag Tag1 indicates that the user does not cognize the learning item (noncognition).

A cognition tag Tag2 indicates that the user cognizes the learning item (cognition) in a cognitive test (e.g., the first cognitive test conducted to determine the cognitive level of the user).

A cognition tag Tag3 indicates that the user memorizes the learning item for a short term (short-term memory).

A cognition tag Tag4 indicates that the user memorizes the learning item for an intermediate term (intermediate memory).

A cognition tag Tag5 indicates that the user memorizes the learning item for a long term (long-term memory).

A cognition tag Tag6 indicates that the user erroneously cognizes the learning item (error).

### 1-1-4. Learning State Database

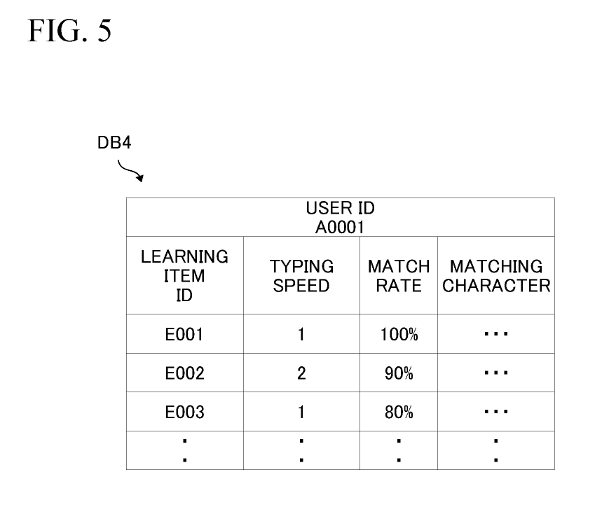

A learning state database according to the present embodiment will be described. FIG. 5 is a diagram showing the data structure of the learning state database shown in FIG. 1.

A user learning state database DB4 stores the results of vocabulary tests (described later).

The learning state database DB4 is associated with a user ID.

The learning state database DB4 includes a learning item ID field, a typing speed difference field, a match rate field, and a matching character field.

The learning item ID field stores learning item IDs.

The typing speed difference field stores information representing a difference between the user normal typing speed and the typing speed measured in a test (e.g., a difference between the number of characters typed normally and the number of characters typed in the test both per 10 seconds).

The match rate field stores information representing the percentage of match between questioned words and characters entered as answers to the questions.

The matching character field stores information representing matching characters between the questioned words and the characters entered as answers.

### 1-1-5. Learning Item Prioritization Database

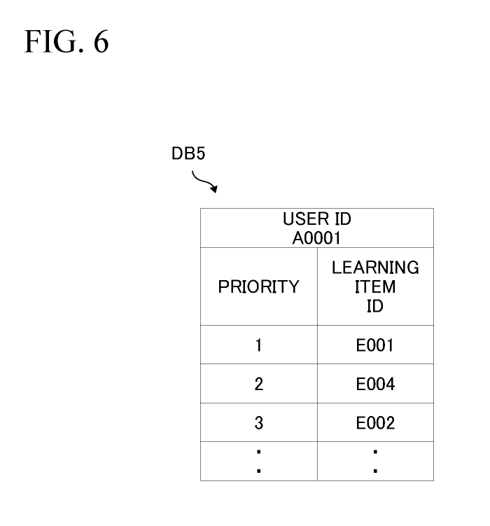

A learning item prioritization database according to the present embodiment will be described. FIG. 6 is a diagram showing the data structure of the learning item prioritization database shown in FIG. 1.

A learning item prioritization database DB5 stores a list of words recorded in accordance with the order of learning priorities used in a long-term memory learning process.

The learning item prioritization database DB5 is associated with a user ID.

The learning item prioritization database DB5 includes a priority field and a learning item ID field.

The priority field stores values representing the priority order. The priority order is determined by, for example, the value in the learning level field, the information in the cognition tag field, or a combination of these.

The learning item ID field stores learning item IDs.

### 1-1-6. Functional Blocks of Management Server

The functional blocks of the management server will be described with reference to FIG. 1.

The basic information collection unit 11, the user learning measurement unit 12, the forgetting speed analysis unit 13, the memory consolidation measurement unit 14, the learning item information creation unit 16, and the communication unit 17 in FIG. 1 are the functional blocks implemented by the management server 1 executing the first learning application program.

The basic information collection unit 11 collects, from the information entered by the user during user registration, basic information including the evaluation information and the user's preferences, gender, and typing speed. The basic information collection unit 11 stores the collected basic information in the user information database DB1.

The user learning measurement unit 12 performs a cognitive test (described later). The user learning measurement unit 12 stores the results of the cognitive test in the cognitive state database DB3.

The forgetting speed analysis unit 13 analyzes the forgetting speed for each word based on the results of a vocabulary test (described later).

The memory consolidation measurement unit 14 analyzes the forgetting speed of each user for each word based on the data stored in the user learning state database DB4. The memory consolidation measurement unit 14 updates the content database DB2 based on the analysis results.

The learning item information creation unit 16 refers to the learning item prioritization database DB5 and creates learning item information for an English word for each user. The learning item information creation unit 16 transmits the created learning item information to the terminal 2 via the communication unit 17.

More specifically, the learning item information creation unit 16 refers to the learning item prioritization database DB5 associated with the user ID obtained from the terminal 2, and obtains the learning item ID identifying the learning item for the user identified by the user ID. The learning item information creation unit 16 retrieves the learning item information associated with the obtained learning item ID from the content database DB2. The learning item information creation unit 16 refers to the evaluation information associated with the user ID in the user information database DB1, and selects a piece of first content with the highest evaluation from the plurality of pieces of first content associated with the learning item in the content database DB2. The learning item information creation unit 16 outputs the retrieved learning item information and the selected first content piece to the terminal 2.

The communication unit 17 transmits the cognitive test data provided by the user learning measurement unit 12, the learning item information created by the learning item information creation unit 16, and the first content piece selected by the learning item information creation unit 16 to the terminal 2. The communication unit 17 provides data including test results transmitted from the terminal 2 to the user learning measurement unit 12, the learning item information creation unit 16, or the memory consolidation measurement unit 14.

### 1-1-7. Relationship Between User Information Database and Content Database

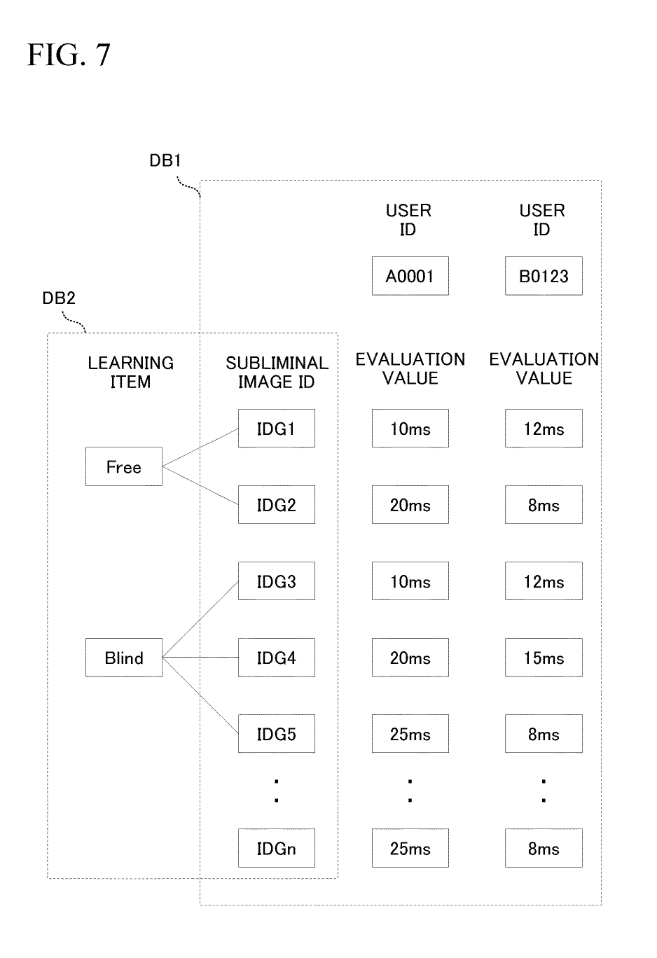

The relationship between the user information database DB1 and the content database DB2 according to the present embodiment will be described. FIG. 7 is a diagram showing the relationship between the user information database in FIG. 2 and the content database in FIG. 3.

In the example shown in FIG. 7, the subliminal image IDs IDG1 and IDG2 are associated with the learning item Free. The subliminal image IDs IDG3 to IDG5 are associated with the learning item Blind. The user A has the user ID A0001. The user B has the user ID B0123.

The learning item Free for the user identified by the user ID A0001 (user name A) has the subliminal images IDs IDG1 and IDG2, of which the subliminal image ID IDG2 has the higher evaluation value (20 ms).

When the learning item information Free is a learning target to be learned by the user (user name A), the learning item information creation unit 16 (FIG. 1) refers to the evaluation information associated with the user ID A0001 in the user information database DB1. The learning item information creation unit 16 selects a piece of first content with the higher evaluation value (subliminal image ID IDG2) from a plurality of pieces of first content associated with the learning item information Free in the content database DB2. The learning item information creation unit 16 outputs the learning item information Free and the selected first content piece to the terminal 2.

The learning item Blind for the user identified by the user ID B0123 (user name B) has the subliminal image IDs IDG3 to IDG5, of which the subliminal image ID IDG4 has the highest evaluation value (15 ms).

When the learning item information Blind is a learning target to be learned by the user (user name B), the learning item information creation unit 16 (FIG. 1) thus refers to the evaluation information associated with the user ID B0123 in the user information database DB1. The learning item information creation unit 16 selects a piece of first content with the highest evaluation value (subliminal image ID IDG4) from a plurality of pieces of first content associated with the learning item information Blind in the content database DB2. The learning item information creation unit 16 outputs the learning item information and the selected first content piece to the terminal 2.

The first content can activate the amygdala of the brain, which controls emotional memory. In the present embodiment, two or more subliminal images are associated with each set of learning item information as shown in FIGS. 2 to 7 to reflect the fact that each subliminal image can have different effects on different users without their conscious awareness. This allows selection of the first content piece that can most strongly activate the user's amygdala based on the user response measured in the terminal 2.

### 1-2. Functions of Terminal

The functions of the terminal 2 will be described with reference to FIG. 1.

The terminal 2 includes, as its function units, an input unit 21, a communication unit 22, a display 23, a storage unit 24, a learning control unit 25, a sound output unit 26, a first reproduction unit 27A, a second reproduction unit 27B, a third reproduction unit 27C, a question presentation unit 27D, and a correct answer presentation unit 27E. These functional blocks are implemented by the terminal 2 executing the second learning application program.

The input unit 21 is used to enter characters or to select images presented in a test.

The communication unit 22 transmits various sets of information input via the input unit 21 to the management server 1. The communication unit 22 receives the second learning application program, cognitive test data, and learning item information transmitted from the management server 1.

The display 23 shows a user registration screen, a cognitive test screen, or an English word learning screen as controlled by the learning control unit 25.

The storage unit 24 stores the second learning application program, cognitive test data, and learning item information received via the communication unit 22.

The learning control unit 25 executes the second learning application program stored in the storage unit 24 to implement the user registration process, the pretest process, a multi-stimulus learning (MSL) process, and a test process (all described later).

The sound output unit 26 outputs a sound (e.g., a sound for assisting memorization of word).

The first reproduction unit 27A reproduces first content that can activate a first site of the user brain in such a manner that the first content is associated with an item to be learned by the user (hereafter referred to as the learning target item). The first site is, for example, the amygdala. In the case that the first content is a subliminal image, the first reproduction unit 27A displays the subliminal image on the display 23. In the case that the first content is a subliminal sound, the first reproduction unit 27A outputs the subliminal sound through the sound output unit 26. This activates the amygdala, which controls emotional memory.

The second reproduction unit 27B reproduces second content that can activate a second site of the user brain in such a manner that the second content is associated with the learning item for the user. The second site is, for example, the hippocampus, the frontal lobe, or a combination of these. In the case that the second content is a normal image, the second reproduction unit 27B displays the normal image on the display 23. In the case that the second content is a normal sound, the second reproduction unit 27B outputs the normal sound through the sound output unit 26. This activates at least one of the hippocampus, which controls semantic memory, or the frontal lobe, which controls prediction.

After the first content and the second content are reproduced, the question presentation unit 27D presents a question to the user using either an image or a sound or both. More specifically, the question presentation unit 27D displays an image representing a question on the display 23 or outputs a message indicating a question from the sound output unit 26.

A question about the learning item to be memorized is presented to the user while activating both of the brain first site for emotional memory and the brain second site for semantic memory. This enhances the association of emotional memory with semantic memory, and enhances memory consolidation.

The correct answer presentation unit 27E presents the correct answer to the question to the user using either an image or a sound or both.

That means, the question presentation unit 27D first presents the question to prompt the user to predict the correct answer, and then the correct answer presentation unit 27E presents the correct answer, instead of simply presenting the correct answer to the user. Allowing the user to predict the correct answer before presenting the correct answer enhances memory consolidation.

The third reproduction unit 27C reproduces third content, which facilitates the release of dopamine in the ventral tegmental area of the user brain, during the period from when the question is presented to when the correct answer is presented, or after the correct answer is presented, or both during and after the period. The third content is, for example, a subliminal image, a subliminal sound, or a combination of these. The release of dopamine in the ventral tegmental area of the brain enhances the association of emotional memory with semantic memory in the insular cortex, and thus enhances memory consolidation. This improves the efficiency of memorization.

### 1-3. Hardware Configuration of Management Server and Terminal

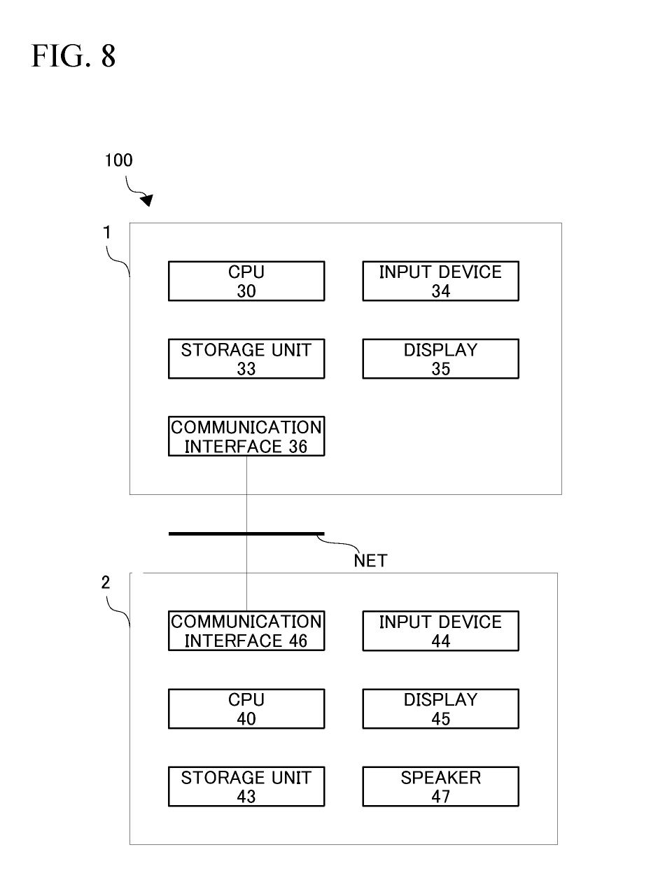

The hardware configuration of the management server 1 and the terminal 2 will be described. FIG. 8 is a diagram showing the hardware configuration of the management server and the terminal in FIG. 1.

As shown in FIG. 8, the management server 1 includes a central processing unit (CPU) 30, a storage unit 33, an input device 34, a display 35, and a communication interface 36.

The CPU 30 controls the entire management server 1. The CPU 30 executes the first learning application program to implement the basic information collection unit 11, the user learning measurement unit 12, the forgetting speed analysis unit 13, the memory consolidation measurement unit 14, and the learning item information creation unit 16.

The storage unit 33 is an example of hardware implementing the storage unit 15 (FIG. 1). The storage unit 33 is, for example, a combination of a random access memory (RAM), a read-only memory (ROM), and a storage (e.g., a hard disk drive, an optical disk drive, or a semiconductor memory reader).

The input device 34 receives input from an operator of the management server 1. The input device 34 is, for example, a keyboard, a mouse, or a combination of these.

The display 35 displays an image corresponding to the results of information processing performed by the CPU 30.

The communication interface 36 is an example of hardware implementing the communication unit 17. The communication interface 36 communicates with an external apparatus (e.g., each terminal 2) through the communication network NET.

The terminal 2 includes a CPU 40, the storage unit 43, an input device 44, a display 45, a communication interface 46, and a speaker 47.

The CPU 40 controls the entire terminal 2. The CPU 40 executes the second learning application program to implement the input unit 21, the display 23, the learning control unit 25, the first reproduction unit 27A, the second reproduction unit 27B, the third reproduction unit 27C, the question presentation unit 27D, and the correct answer presentation unit 27E.

The storage unit 43 is an example of hardware implementing the storage unit 24. The storage unit 43 is a combination of a RAM, a ROM, and a storage.

The input device 44 is an example of hardware implementing the input unit 21. The input device 44 receives an instruction from the user of the terminal 2. The input device 44 is a keyboard, a mouse, a numeric keypad, a touch panel, or a combination of these.

The display 45 is an example of hardware implementing the display 23. The display 45 shows an image corresponding to the results of information processing performed by the CPU 40.

The communication interface 46 is an example of hardware implementing the communication unit 22. The communication interface 46 communicates with an external apparatus (e.g., the management server 1) through the communication network NET.

The speaker 47 is an example of hardware implementing the sound output unit 26. The speaker 47 may be an earphone.

### 2. Information Processing

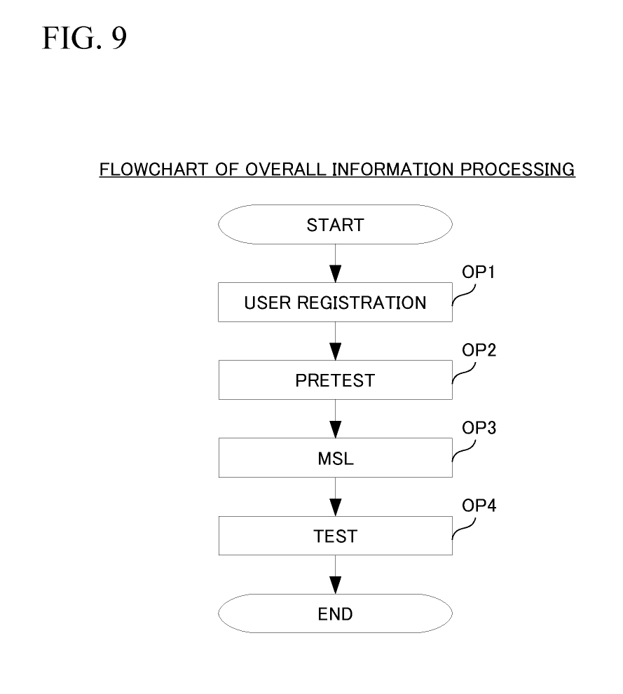

The information processing according to the present embodiment will be described. FIG. 9 is a flowchart illustrating the overall information processing according to the embodiment of the present invention.

The information processing according to the present embodiment is implemented by the management server 1 executing the first learning application program and by the terminal 2 executing the second learning application program.

As shown in FIG. 9, the information processing according to the present embodiment includes a user registration process (OP1).

The user registration process (OP1) is followed by a pretest process (OP2).

The pretest process (OP2) is followed by a MSL process (OP3). The MSL is a learning scheme that uses the activation of the brain behavior triggered by stimuli such as an overt image, a latent image, an overt sound, a latent sound, a meaning, an episode, and a predicted difference. The MSL process (OP3) enables the user to efficiently memorize a learning target.

The MSL process (OP3) is followed by a test process (OP4). In the test process (OP4), a test (e.g., a vocabulary test) is conducted to measure memory consolidation of the user for the learning item memorized by the user in the MSL process (OP3).

### 2-1. User Registration Process

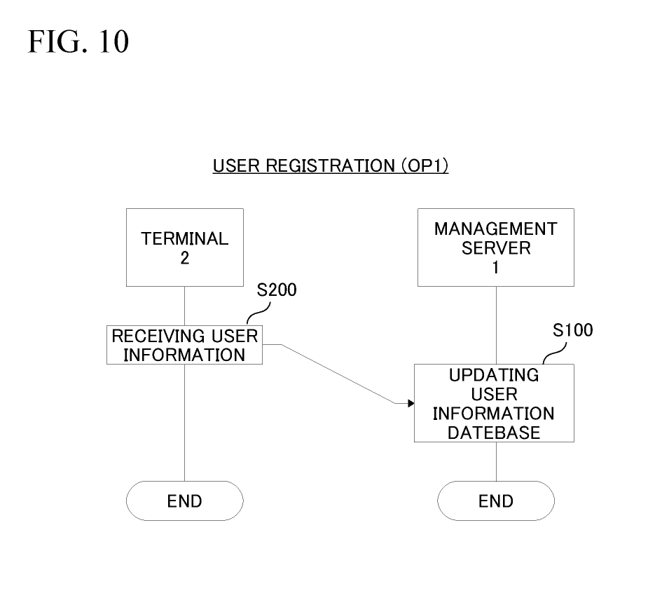

The user registration process (OP1) according to the present embodiment will be described. FIG. 10 is a sequence diagram illustrating the user registration process in FIG. 9.

As shown in FIG. 10, the terminal 2 receives user information (S200).

More specifically, in response to a predetermined instruction provided by the user operating the input device 44, the CPU 40 activates the second learning application program stored in the storage unit 43.

The CPU 40 displays an entry screen for entry of user information on the display 45. The entry screen includes a plurality of entry fields for entry of user information (e.g., a user name, a gender, a date of birth, an age, and an email address).

When the user enters the user information in the entry fields by operating the input device 44, the CPU 40 determines the normal typing speed of the user.

The CPU 40 then transmits information representing the determined normal typing speed and the entered user information to the management server 1 via the communication interface 46.

The management server 1 updates the user information database (S100).

More specifically, the CPU 30 adds a new record to the user information database DB1 (FIG. 2) when receiving the user information transmitted from the terminal 2 via the communication interface 36. The CPU 30 stores the new user ID in the user ID field of the new record. The CPU 30 also stores the information representing the normal typing speed in the normal typing speed field of the new record. The CPU 30 also stores the user information in the user name field, the gender field, and the date of birth field of the new record.

### 2-2. Pretest Process

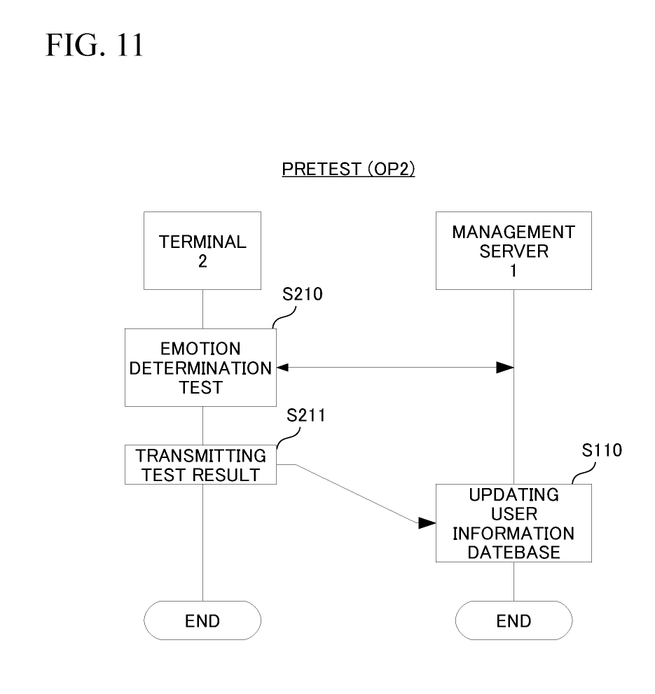

The pretest process (OP2) according to the present embodiment will be described. FIG. 11 is a sequence diagram illustrating the pretest process in FIG. 9.

As shown in FIG. 11, the terminal 2 conducts an emotion determination test (S210) in communication with the management server 1. In the emotion determination test (S210), the user's emotion including its mood and feeling is determined.

The emotion determination test (S210) uses first content reproduced for a time period so short that the user does not cognize the content and measures a user response to a stimulus given by the first content to the user without his or her conscious awareness. The emotion determination test includes a first emotion determination test, a second emotion determination test, or a combination of these.

### 2-2-1. First Emotion Determination Test

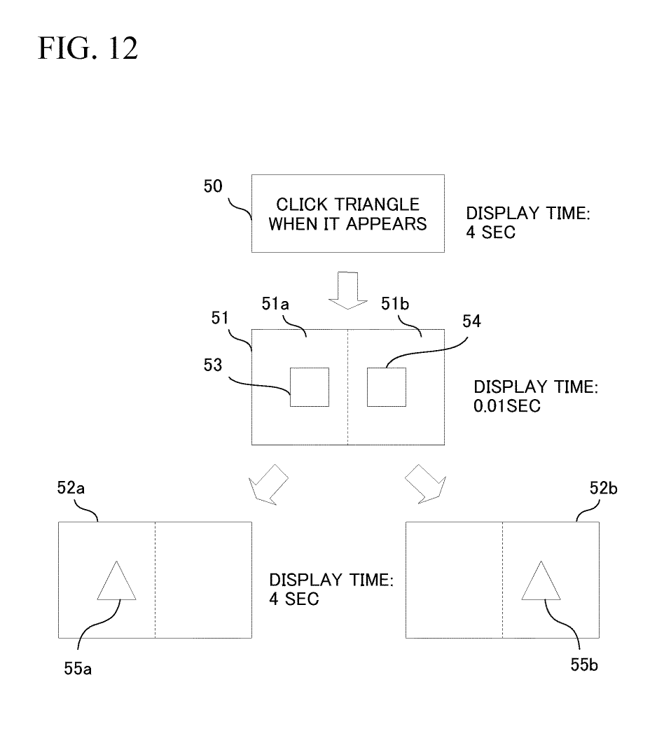

The first emotion determination test will be described. FIG. 12 is a diagram showing a display example for the first emotion determination test according to the present embodiment.

The first emotion determination test is used when the first content is a subliminal image.

As shown in FIG. 12, the CPU 40 displays a screen 50 on the display 45. The screen 50 includes a message indicating, for example, “Click a triangle when it appears.” This screen 50 is displayed, for example, for four seconds.

The CPU 40 then displays a screen 51 on the display 45 as shown in FIG. 12.

The screen 51 has a left area Ma on which a first subliminal image 53 appears, and a right area 51b on which a second subliminal image 54 appears. The first subliminal image 53 and the second subliminal image 54 are displayed next to each other.

The first subliminal image 53 and the second subliminal image 54 correspond to, for example, the subliminal image data Ga1 and the subliminal image data Ga2 (FIG. 3). The first subliminal image 53 and the second subliminal image 54 are, for example, square images.

The screen 51 is displayed for 0.01 seconds (or for a time period much shorter than the display time of the screen 50). Thus, the user does not visually cognize the first subliminal image 53 and the second subliminal image 54. These images can usually be captured by the brain without its conscious awareness (in subconscious mind or at the boundary between conscious mind and subconscious mind). The user thus directs attention to either the first subliminal image 53 or the second subliminal image 54 without his or her conscious awareness. This phenomenon is called the subliminal effect. The present embodiment uses this subliminal effect.

The CPU 40 then displays a screen 52a or 52b on the display 45. The screen 52a includes a triangular image 55a. The screen 52b includes a triangular image 55b.

The user can click the triangular image 55a or 55b by operating the input device 44 in response to the message on the screen 50.

The CPU 40 then stores the period of time from when the screen 52a or 52b is displayed to when the user clicks the image 55a or 55b (hereafter referred to as the response time) in the storage unit 43.

When the user has directed attention to the first subliminal image 53 in the screen 51, the response time to the triangular image 55a, which appears on the same side as the first subliminal image 53 (or opposite to the second subliminal image 54), is shorter than the response time to the triangular image 55b.

When the user has directed attention to the second subliminal image 54, the response time to the image 55a is longer than the response time to the image 55b.

The first emotion determination test involves repeated displaying of the subliminal images and measuring of the response time several times. This yields the absolute and relative response times for the plurality of subliminal images.

### 2-2-2. Second Emotion Determination Test

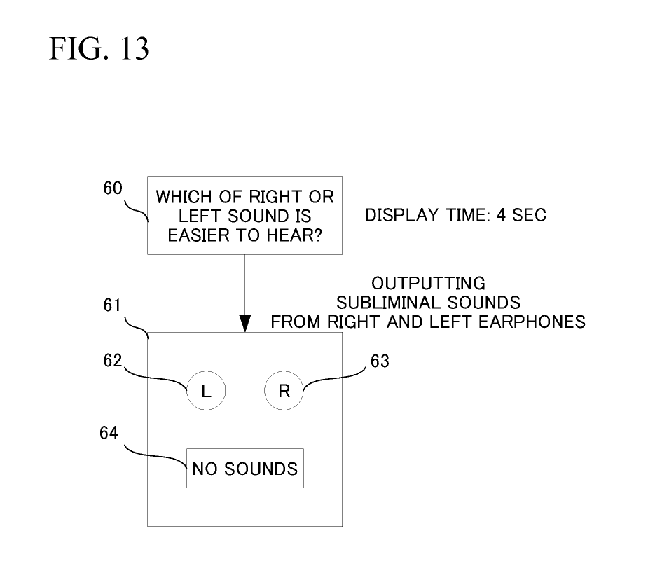

The second emotion determination test will be described. FIG. 13 is a diagram showing a display example for the second emotion determination test according to the present embodiment.

The second emotion determination test is used when the first content is a subliminal sound.

The CPU 40 displays a screen 60 on the display 45. The screen 60 includes a message indicating, for example, “Which of the right or left sound is easier to hear?”

The CPU 40 then outputs two subliminal sounds from the speaker 47. The two subliminal sounds correspond to, for example, the subliminal sound data Sa1 and the subliminal sound data Sa2 (FIG. 3).

The CPU 40 displays a screen 61 on the display 45. The screen 61 includes a “left” button 62 to be pressed when the user hears the left sound, a “right” button 63 to be pressed when the user hears the right sound, and a “no-sound” button 64 to be pressed when the user hears none of the sounds.

The CPU 40 alternately outputs the subliminal sounds from the right and left earphones.

The user can click one of the buttons 62 to 64 by operating the input device 44.

The second emotion determination test involves repeated reproducing of the subliminal sounds and determining of the order of the user's preferences several times. This yields the relative preferences of the user for the plurality of subliminal sounds.

As shown in FIG. 11, after the processing in step S210 is complete, the terminal 2 transmits the test results (S211).

More specifically, the CPU 40 transmits the test data representing the test results to the management server 1 via the communication interface 46.

The test data obtained from the first emotion determination test includes the user ID, the subliminal image ID (e.g., IDG1), and the response time information in a manner associated with one another. The response time information is an example of the evaluation information.

The test data obtained from the second emotion determination test includes the user ID, the subliminal sound ID (e.g., IDS1), and information indicating the order of the user's preferences in a manner associated with one another. The information indicating the order of the user's preferences is an example of the evaluation information.

The management server 1 updates the user information database (S110).

More specifically, the CPU 30 determines the user information database DB1 (FIG. 2) associated with the user ID included in the test data transmitted in S221.

When the test data corresponds to the first emotion determination test, the CPU 30 stores, into the determined user information database DB1, the subliminal image ID and the response time information (evaluation information) that are included in the test data in a manner associated with each other. When the test data corresponds to the second emotion determination test, the CPU 30 stores, into the identified user information database DB1, the subliminal sound ID and the information indicating the order of preferences (evaluation information) that are included in the test data in a manner associated with each other.

### 2-3. MSL Process

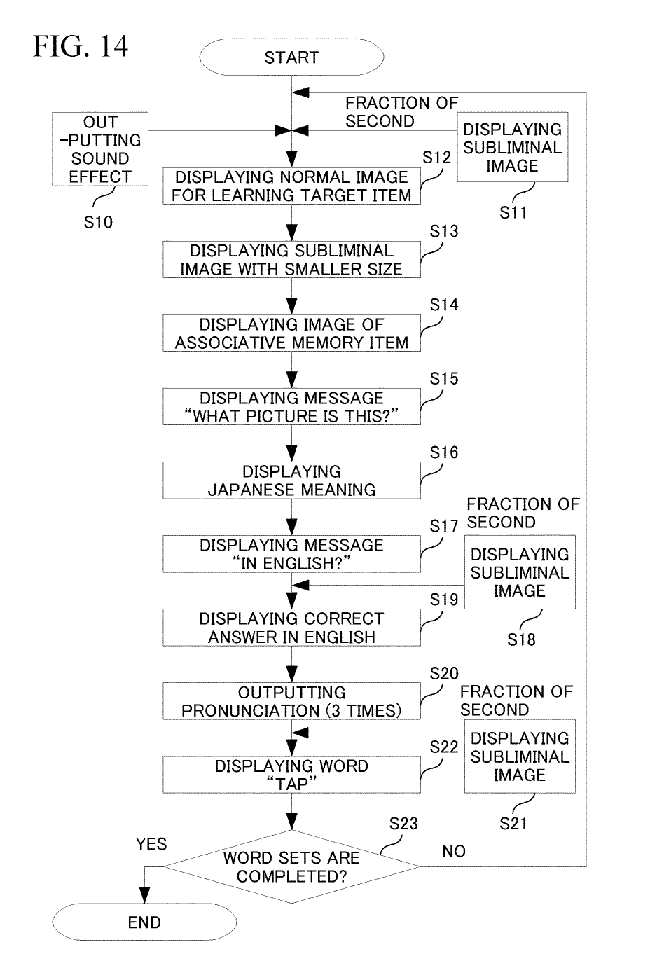

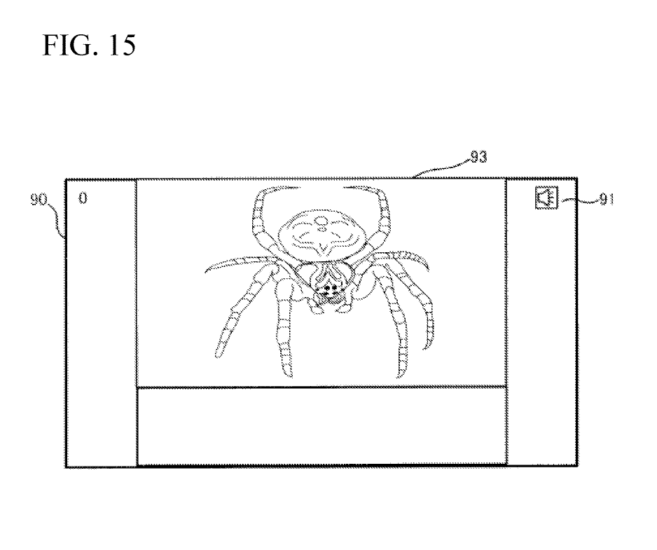

The MSL process (OP3) according to the present embodiment will be described. FIG. 14 is a flowchart of the MSL process in FIG. 9. FIGS. 15 to 22 show display examples in the MSL process shown in FIG. 14.

In this example, the word “Blind” is to be learned (learning target item). In the example described below, the time in parentheses like (0:00) represents the time passing from the start of the MSL process.

As shown in FIG. 14, the CPU 40 starts the MSL process (0:00), and outputs, from the speaker 47, a sound effect (subliminal sound) representing the emotion information that is associated with the learning target item Blind (S10) for a fraction of a second.

Simultaneously with the output of the subliminal sound (S10), the CPU 40 also displays a subliminal image representing the emotion information in a first display space (first display area) 93 of a screen 90 (S11) for a fraction of a second.

The subliminal sound and the subliminal image are both associated with the learning target item, and affect the emotions of the user. This activates the amygdala of the user.

In S10 and S11, the CPU 40 functions as the first reproduction unit 27A.

In this example, the learning target item is the word Blind, which has a negative meaning. The CPU 40 thus outputs a sound arousing a negative emotion of the user from the speaker 47. A speaker icon 91 in FIG. 15 indicates that a sound is being output from the speaker 47.

The CPU 40 also displays an image arousing a negative emotion (e.g., a spider image in FIG. 15) in the first display space 93. The image is displayed, for example, for 0.01 seconds.

In this example, as shown in FIG. 7, the learning item Blind is assigned three subliminal images (subliminal image IDs IDS3 to IDG5). The subliminal image ID IDG3 is a skull image, the subliminal image ID IDG4 is a withered flower image, and the subliminal image ID IDG5 is a spider image. When the user has the user ID A0001, the selected image is the spider image corresponding to the subliminal image ID IDG5, which has the highest evaluation value (the longest response time).

More specifically, in the emotion determination process (OP2), the responses of each user to a plurality of subliminal images used as the first content is evaluated. Based on the evaluation results, the subliminal image most effective for the user is selected from the subliminal images associated with the learning item, and the selected subliminal image is displayed. This allows selective display of the subliminal image that fits the sensitivity of each user. This activates the amygdala of the user.

Subsequently in 0.01 seconds, the CPU 40 then displays a normal image for the learning target item in the first display space 93 (0:01, S12).

For example, the CPU 40 determines the normal image ID (e.g., IDN2) associated with the learning item Blind (learning item ID E002) in the content database DB2 (FIG. 2).

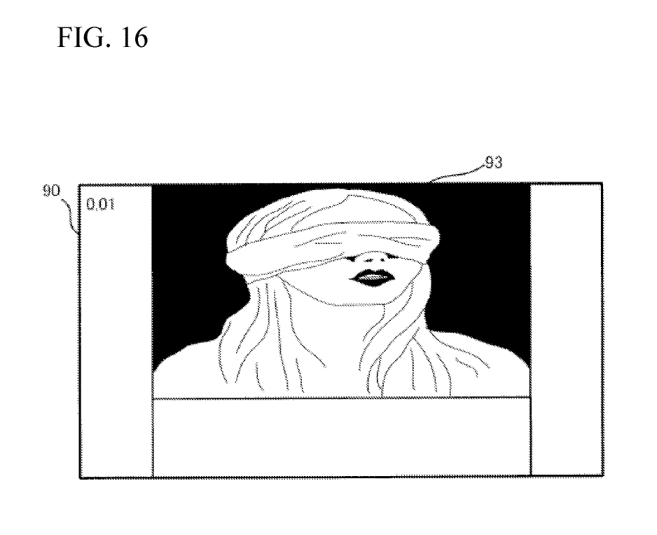

As shown in FIG. 16, the CPU 40 then displays the image identified by the determined normal image ID IDN2 (an image of a blindfolded woman) in the first display space 93 of the screen 90. The normal image is displayed, for example, for 0.09 seconds.

The displayed normal image relates to the information stored in the meaning field associated with the learning item ID E002 in the content database DB2. This allows activation of the hippocampus, which controls semantic memory, and the frontal lobe, which controls prediction, in the user brain.

In S12, the CPU 40 functions as the second reproduction unit 27B.

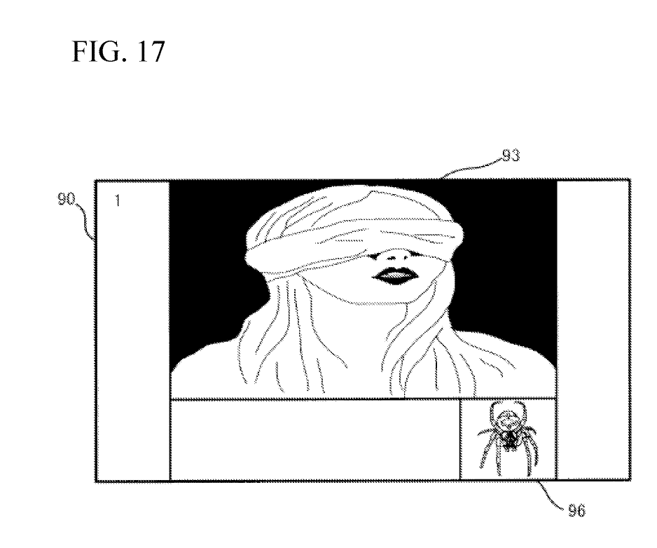

As shown in FIG. 17, the CPU 40 then displays the subliminal image displayed in S11 again with a smaller size for a fraction of a second in a second display space (second display area) 96 (1:00, S13). In the example shown in FIG. 17, the subliminal image displayed in S11 (spider image) is displayed in the second display space 96 immediately below the normal image (an image of a blindfolded woman) displayed in S12. The smaller subliminal image is displayed, for exmple, for 0.01 seconds.

In S13, the CPU 40 functions as the first reproduction unit 27A.

In this manner, the second content is reproduced after the first content is reproduced, and then the first content is reproduced again while the second content is being displayed. The second content interposed between the first contents that are reproduced two times can stimulate the user brain. This allows further activation of the amygdala and the hippocampus of the user.

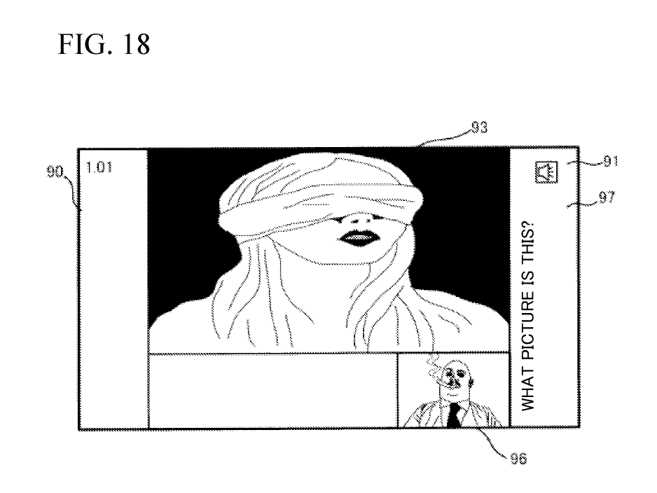

As shown in FIG. 18, the CPU 40 then displays the image of an associative memory item (hereafter referred to as the relevant image) in the second display space (second display area) 96 (S14), and prompts the user to predict the picture represented by the relevant image (1:01, S15).

The brain tends to memorize multiple items in an associated manner. The present embodiment uses this capability of the brain. The learning item is memorized simultaneously with the associative memory item (associative memory). The learning item (first item) is the word “Blind.” The associative memory item (second item) is the word “Boss.” The first display space 93 is larger than the second display space 96. This is because the first item has a higher priority level for learning than the second item. In other words, the memory of the second item (associative memory) is supplementary to the memory of the first item. An item with a lower degree of difficulty than the first item is selected as the second item. More specifically, an English word to be learned using an image displayed in the second display space 96 has a lower degree of difficulty than an English word to be learned using an image displayed in the first display space 93.

In this manner, the first item having the higher priority is displayed in a manner more noticeable than the second item having the lower priority. The second item has undergone more enhanced memory consolidation than the first item. The user can associate the second item with the first item to memorize the first item more efficiently.

The second item is displayed in a manner less noticeable than the first item. This prevents the second item from disturbing the user's memorization of the first item.

In S14, the CPU 40 functions as the second reproduction unit 27B.

In the example shown in FIG. 18, a relevant image (an image of a man with a cigar in his mouth) is displayed in the second display space 96, a message indicating “What picture is this?” is displayed in a blank area 97, and a voice asking “What picture is this?” is output from the speaker 47. The relevant image is displayed, for example, for 2.99 seconds. In this manner, the user is prompted to think of the picture represented by the image appearing in the first display space 93. Creating a gap between the brain expectation and the correct answer allows effective learning in the process of brain memorization.

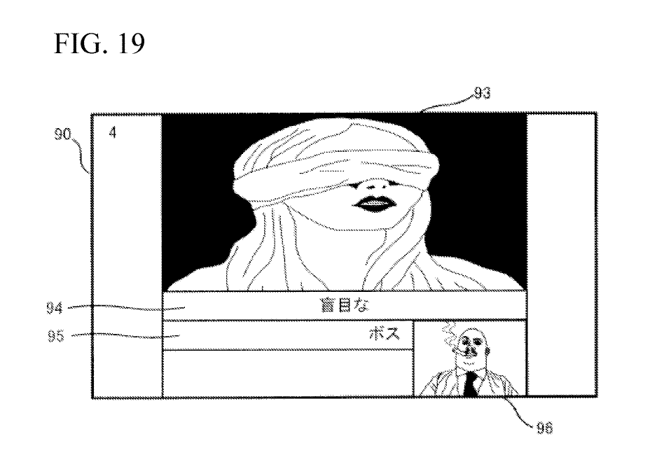

As shown in FIG. 19, the CPU 40 then displays the meaning of the learning target item in Japanese in a third display space 94 and a fourth display space 95 (4:00, S16).

In the example shown in FIG. 19, the third display space 94 shows Japanese characters meaning “blind” and the fourth display space 95 shows Japanese characters meaning “boss.” These characters are displayed, for example, for 0.5 seconds.

In S16, the CPU 40 functions as the second reproduction unit 27B.

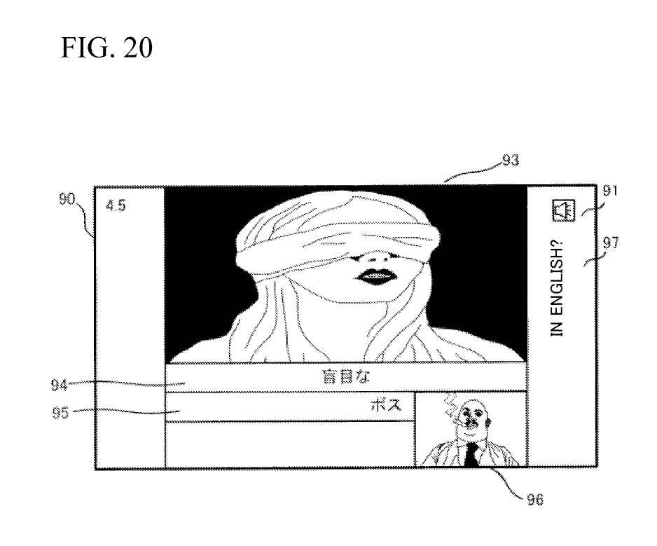

The CPU 40 subsequently prompts the user to predict how to express the displayed Japanese words in English (4:50, S17). In the example shown in FIG. 20, the CPU 40 displays a message indicating “In English?” in the blank area 97. The CPU 40 also outputs a voice asking “In English?” from the speaker 47. In this manner, the user is prompted to think of how to express the Japanese characters displayed in the third display space 94 in English. The message in the blank area 97 is displayed, for example, for 2.50 seconds.

In S17, the CPU 40 functions as the question presentation unit 27D.

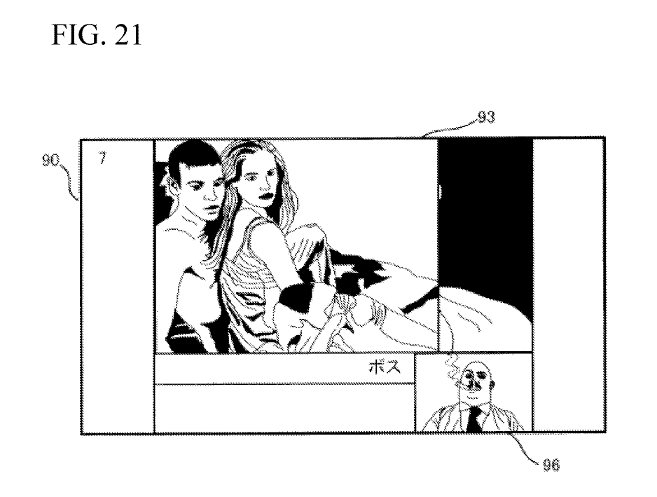

The CPU 40 then displays a subliminal image triggering the release of user dopamine in the first display space 93 for a fraction of a second (7:00, S18). In the example shown in FIG. 21, the CPU 40 displays a subliminal image (an image of a man and a woman close together) in the first display space 93. The subliminal image is displayed, for example, for 0.01 seconds.

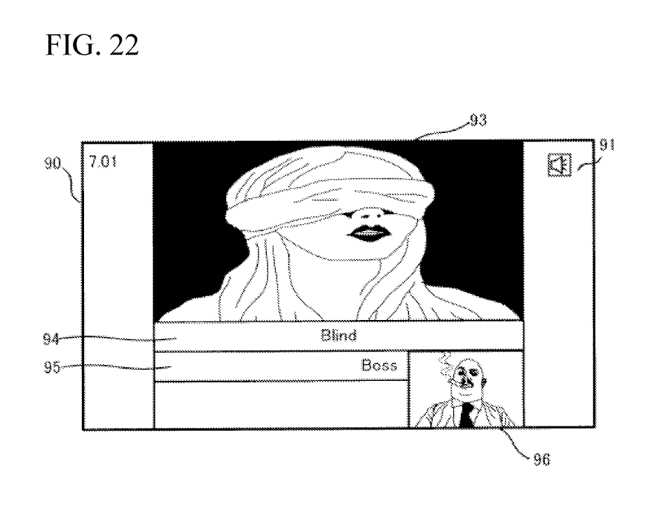

As shown in FIG. 22, the CPU 40 then displays the correct answers, or the English words for the Japanese displayed in the third display space 94 and the fourth display space 95 (7:01, S19). In the example shown in FIG. 22, the CPU 40 displays the characters “Blind” in the third display space 94 and “Boss” in the fourth display space 95. These characters are displayed, for example, for 4.99 seconds.

Simultaneously with the processing in S19, the CPU 40 outputs the voice of an English word corresponding to the correct answer from the speaker 47 a predetermined number of times (e.g., three times) (S20).

In S19 and S20, the CPU 40 functions as the correct answer presentation unit 27E.

Either S19 or S20 may be eliminated. In other words, the correct answer may be presented with either characters or voice only.

The CPU 40 then displays the subliminal image triggering the release of user dopamine in the first display space 93 again for a fraction of a second (12:00, S21). As shown in FIG. 21, for example, the CPU 40 displays the subliminal image (the image of a man and a woman close together) in the first display space 93. The subliminal image is displayed, for example, for 0.01 seconds. As shown in FIG. 22, the CPU 40 subsequently displays the image displayed in S19 in the first display space 93.

This facilitates the release of dopamine in the ventral tegmental area of the user brain. The dopamine enhances the association of emotional memory with semantic memory in the insular cortex, and thus enhances memory consolidation.

In S21, the CPU 40 functions as the third reproduction unit 27C.

The CPU 40 subsequently superimposes the word “Tap” on the image associated with the learning target item (e.g., the image displayed in the first display space 93 shown in FIG. 22) (14:00, S22). This prompts a user operation for the image associated with the learning target item.

When the user taps the screen, the CPU 40 determines whether the MSL process has been completed for all word sets (S23). When the MSL process has not been completed for all word sets (S23: No), the CPU 40 displays the word “Next” in a lower area of the second display space 96 (15:00 to 20:00), and starts the MSL process for the next word.

In the present embodiment, the characters of a word to be learned as well as an image associated with the word and a subliminal image representing emotion information associated with the word are reproduced, and a subliminal sound representing the emotion information associated with the word is reproduced. Further, the user is prompted to think of the correct answer at an appropriate timing. A subliminal image for triggering the release of dopamine is reproduced. The word, an image associated with the word, a memorized word, and an image associated with the memorized word are displayed to allow the user to learn the word with the aid of associative memory. In this manner, multiple stimuli can activate the brain. This greatly improves the efficiency of memorization.

In the process of brain memorization, activating the brain site responsible for word learning together with the brain site responsible for emotions is known to enhance memory consolidation. Thus, more preferably, an emotional sound is reproduced and a subliminal image is displayed for a word affecting emotions.

### 3. Modifications

Modifications of the embodiment will be described. The modifications described below may be combined with the embodiment or with other modifications as appropriate.

The pretest process (OP2) may be a combination of the first emotion determination test and the second emotion determination test.

In the pretest process (OP2), the management server 1 may conduct a cognitive test in addition to the emotion determination test (S210). The cognitive test intends to check the cognitive state for each learning item. After the cognitive test, the management server 1 may update the cognitive state database DB3 to reflect the results of the cognitive test. In the MSL process (OP3), the management server 1 refers to the cognitive state database DB3 and selects the content to be reproduced in each step.

In the emotion determination test (the first emotion determination test and the second emotion determination test), the evaluation values may be adjusted based on the performance of the display 45 of the terminal 2 used for the emotion determination test (e.g., the contrast ratio, the luminance, the resolution, the screen size, the color tone, the response time, or a combination of these).

The performance of the display 45 can affect impressions received by the user when a subliminal image appears. The evaluation values may thus include evaluation errors depending on the performance of the display 45. In this modification, the evaluation values can be adjusted based on the performance of the display 45 to reduce such evaluation errors caused by the display performance. This allows selection of a subliminal image that can optimally activate the amygdala.

In the emotion determination test, the evaluation values of the third content may be obtained. The evaluation values of the third content are obtained in the same manner as the evaluation values of the first content. The obtained evaluation values of the third content are stored in the user information database DB1 (FIG. 2) in the same manner as the evaluation values of the first content.

In the above embodiment, the first content is not associated with users or with learning items. The same first content is commonly presented to multiple users in the MSL process (OP3). This saves the capacity of at least the storage unit 33 or 43.

The first content may be associated with learning items. In this case, the subliminal image IDs and the subliminal sound IDs are associated with the learning item IDs in the content database DB2 (FIG. 3). The MSL process (OP3) uses either a subliminal image ID or a subliminal sound ID or both associated with a learning item ID. The first content associated with the learning item is then presented to the user.

The first content may be associated with users. In this case, the subliminal image IDs and the subliminal sound IDs are associated with the user IDs in the user information database DB1 (FIG. 2). The MSL process (OP3) uses either a subliminal image ID or a subliminal sound ID or both associated with a user ID. The first content associated with the user is then presented to the user.

The first content associated with the user may be determined by the preferences of the user. In this case, a first content piece (e.g., a subliminal image) with the highest evaluation value in the user information database DB1 may be presented as the first content. This allows the user to learn a learning item using a first content piece that fits the preferences of the user.

The tag field (FIG. 3) may also store tags indicating types of emotional stimuli classified in the neuroscience. The tags may indicate the emotional stimuli, for example, listed below:
surprise/boredom
enthusiasm/apathy
affection
mercy/mercilessness
joy
pleasure/displeasure
fear
peace/anxiety
anger
sorrow
emptiness
pain
shame
freedom

The first subliminal image 53 and the second subliminal image 54 displayed in the first emotion determination test may be a set of images with the opposite concepts.
Sets of images with the opposite concepts are, for example, listed below:
an image giving a positive impression and an image giving a negative impression
joyful and sorrowful face images
blooming and withered flower images
an image of persons hugging each other and an image of persons glaring at each other
images of a man and a woman
images of a child and an aged person
images of a single person and a crowd
images of a daytime and a night
images of summer and winter.

Such images with the opposite concepts can be used to easily determine the tendency in preferences based on human emotions.

In the MSL process (OP3), a learning target item may be selected depending on the cognitive state of the user.

In the cognitive state database DB3 (FIG. 4), the learning item IDs with the cognition tag Tag1 are obtained. In the content database DB2 (FIG. 2), the learning item IDs for each tag are counted. For example, when the count number of the learning item IDs is the largest for the tag Tag3, the learning item identified by the learning item ID with the tag Tag3 (the learning item giving a positive impression) is selected as the learning target item used in the MSL process (OP3).

The management server 1 may receive registration of content from the user.

For example, the storage unit 43 stores multiple pieces of image data.

The display 45 shows a message indicating, for example, “Upload picture(s) of food you like.”

The user operates the input device 44 to select a piece of image data to be uploaded from the multiple pieces of image data.

The CPU 40 then transmits the selected image data piece to the management server 1 via the communication interface 46.

The CPU 30 receives the image data piece transmitted from the terminal 2 via the communication interface 36.

The CPU 30 then stores the received image data piece in a manner associated with the learning item ID for identifying the learning item “eat” in the content database DB2 (FIG. 3).

The CPU 30 then displays the image corresponding to the image data piece on the terminal 2 in the first emotion determination test.

The image registered by the user can thus be reproduced when the learning target item in the MSL process (OP3) is the learning item “eat.”

The learning item may not be an English word, and may be any item for learning another language or any other subject (e.g., history, medicine, and law, or a learning subject in preparation for a certification test).

The terminal 2 may include at least one of the functions of the management server 1.

The management server 1 may include at least one of the functions of the terminal 2.

The storage unit 43 may be arranged external to the terminal 2. In this case, the terminal 2 accesses the storage unit 43 through the communication network NET.

The storage unit 33 may be arranged external to the management server 1. In this case, the management server 1 accesses the storage unit 33 through the communication network NET.

The display areas for subliminal images and normal images may not be those described with reference to FIGS. 15 to 22.

For example, a subliminal image may be displayed in the first display space 93 shown in FIG. 17, and a normal image may be displayed in the second display space 96.

In this case, the CPU 30 may determine the display area for a subliminal image and the display area for a normal image in accordance with a user instruction.

The CPU 30 may also determine the display area for a subliminal image and the display area for a normal image in accordance with the learning state or the cognitive state of the user, or a combination of these.

Although the embodiments of the present invention have been described in detail, the scope of the present invention is not limited to the embodiments. The embodiments may be modified and changed variously without departing from the spirit and scope of the invention. The embodiments and the modifications described above may also be combined.

What is claimed is:

1. A computer implemented method, comprising:
reproducing first content activating a first site of a user brain, the first content being associated with a learning target item to be learned by the user;
reproducing second content activating a second site of the user brain, the second content being associated with the learning target item;
presenting a question about the learning target item after the first content and the second content are reproduced; and
presenting a correct answer to the question.

2. The method according to claim 1, wherein
the first site is an amygdala, and
the second site is a hippocampus.

3. The method according to claim 1, further comprising reproducing third content facilitating release of dopamine in a ventral tegmental area of the user brain during a period from when the question is presented to when the correct answer is presented, or after the correct answer is presented, or both during and after the period.

4. The method according to claim 1, wherein
the first content includes an image associated with the learning target item, and
reproducing the first content includes reproducing the image so that the user does not visually cognize the image and the user is stimulated without conscious awareness.

5. The method according to claim 1, wherein
the first content includes a sound associated with the learning target item, and
reproducing the first content includes reproducing the sound so that the user does not aurally cognize the sound and the user is stimulated without conscious awareness.

6. The method according to claim 1, wherein
the second content is at least one of an image associated with a meaning of the learning target item and visually cognized, or a sound associated with the meaning of the learning target item and aurally cognized.

7. The method according to claim 1, wherein
reproducing the second content includes displaying a first normal image associated with a first learning item that is the learning target item in a manner to have a first size on a display, and displaying a second normal image associated with a second learning item that has a lower degree of difficulty than the first learning item in a manner to have a second size larger than the first size on the display,
presenting question includes presenting the question about each of the first learning item and the second learning item, and
presenting the correct answer includes presenting the correct answer to the question about each of the first learning item and the second learning item.

8. A management apparatus, comprising:
a first reproduction unit configured to reproduce first content activating a first site of a user brain, the first content being associated with a learning target item to be learned by the user;
a second reproduction unit configured to reproduce second content activating a second site of the user brain, the second content being associated with the learning target item;
a question presentation unit configured to present a question about the learning target item after the first content and the second content are reproduced; and
a correct answer presentation unit configured to present a correct answer to the question.

9. The management apparatus according to claim 8, wherein
the first site is an amygdala, and
the second site is a hippocampus.

10. The management apparatus according to claim 8, further comprising a third reproduction unit configured to reproduce third content facilitating release of dopamine in a ventral tegmental area of the user brain during a period from when the question is presented to when the correct answer is presented, or after the correct answer is presented, or both during and after the period.

11. The management apparatus according to claim 8, wherein
the first content includes an image associated with the learning target item, and
the first reproduction unit reproduces the image so that the user does not visually cognize the image and the user is stimulated without conscious awareness.

12. The management apparatus according to claim 8, wherein
the first content includes a sound associated with the learning target item, and
the first reproduction unit reproduces the sound so that the user does not aurally cognize and the user is stimulated without conscious awareness.

13. The management apparatus according to claim 8, wherein
the second content is at least one of an image associated with a meaning of the learning target item and visually cognized, or a sound associated with the meaning of the learning target item and aurally cognized.

14. The management apparatus according to claim 8, wherein
the second reproduction unit displays a first normal image associated with a first learning item that is the learning target item in a manner to have a first size on a display, and the second reproduction unit displays a second normal image associated with a second learning item that has a lower degree of difficulty than the first learning item in a manner to have a second size larger than the first size on the display,
the question presentation unit presents a question about each of the first learning item and the second learning item, and
the correct answer presentation unit presents a correct answer to the question about each of the first learning item and the second learning item.

15. A non-transitory computer readable medium comprising instructions for execution by a processor, the instructions comprising:
a first reproduction instructions configured to reproduce first content activating a first site of a user brain, the first content being associated with a learning target item to be learned by the user;
a second reproduction instructions configured to reproduce second content activating a second site of the user brain, the second content being associated with the learning target item;
a question presentation instructions configured to present a question about the learning target item after the first content and the second content are reproduced; and
a correct answer presentation unit configured to present a correct answer to the question.

16. The non-transitory computer readable medium according to claim 15, wherein
the first site is an amygdala, and
the second site is a hippocampus.

17. The non-transitory computer readable medium according to claim 15, wherein the instructions further comprising a third reproduction instructions configured to reproduce third content facilitating release of dopamine in a ventral tegmental area of the user brain during a period from when the question is presented to when the correct answer is presented, or after the correct answer is presented, or both during and after the period.

18. The non-transitory computer readable medium according to claim 15, wherein
the first content includes an image associated with the learning target item, and
the first reproduction instructions reproduces the image so that the user does not visually cognized and the user is stimulated without conscious awareness.

19. The non-transitory computer readable medium according to claim 15, wherein
the first content includes a sound associated with the learning target item, and
the first reproduction instructions reproduces the sound so that the user does not aurally cognize and the user is stimulated without conscious awareness.

20. The non-transitory computer readable medium according to claim 15, wherein
the second content is at least one of an image associated with a meaning of the learning target item and visually cognized, or a sound associated with the meaning of the learning target item and aurally cognized.
